(19) United States
(12) Patent Application Publication
(10) Pub. No.: US 2025/0129290 A1
(43) Pub. Date: Apr. 24, 2025

(54) CONTINUOUS CARBONISATION SYSTEM AND METHODS THEREFOR

(71) Applicant: OCS IP Pty Ltd, Sydney, New South Wales (AU)

(72) Inventors: Joseph TAOUK, Sydney (AU); Barnaby Jonathan BRUCE, Drouin (AU)

(21) Appl. No.: 18/725,927

(22) PCT Filed: Dec. 29, 2022
(86) PCT No.: PCT/AU2022/051600

§ 371 Date: Jul. 1, 2024

(30) Foreign Application Priority Data
Dec. 29, 2021 (AU) 2021904294

(51) Int. Cl. C10B 49/10; B09B 3/40; B09B 101/25; C10B 1/04; C10B 19/00; C10B 49/06

(52) U.S. Cl. CPC C10B 49/10; B09B 3/40; C10B 1/04; C10B 19/00; C10B 49/06; B09B 2101/25

(57) ABSTRACT

A continuous organic carbonisation system (OCS) and methods therefor include a pressurisable reactor vessel that is configured for receiving organic matter for carbonisation at an inlet, via a continuous feed valve that is a rotary airlock valve or a trickle valve. A similar feed valve feeds carbonised matter out of the reactor vessel. The reactor vessel defines an unobstructed hollow heating portion that is preferably vertically oriented. The OCS further includes a heating circuit for heating a pressurised dioxygen deficient working gas, which is used as a heat transfer fluid. The OCS further includes a cooling portion that may be a lower length of the reactor vessel, or may be provided as a separate vessel. The cooling portion may be cooled by cooling gas circulating in a cooling circuit.

This application is the U.S. national phase of International Application No. PCT/AU2022/051600 filed Dec. 29, 2022 which designated the U.S. and claims priority to Australian Patent Application No. 2021904294 filed Dec. 29, 2021, the entire contents of each of which are hereby incorporated by reference.

### FIELD OF THE INVENTION

The present invention relates to a carbonisation system and methods therefor and in particular to a system for carbonising organic matter.

The invention has been developed primarily for use in/with waste organic matter and will be described hereinafter with reference to this application. However, it will be appreciated that the invention is not limited to this particular field of use.

### BACKGROUND OF THE INVENTION

At present, large amounts of organic waste is produced by society. This includes waste generated from households, hospitals, municipal councils and industry. Such waste is of a wide variety of sizes and shapes, and may include pathogenic material.

The burning of organic waste by combustion in a furnace is not ideal as this results in the release of large amounts of carbon dioxide and carbon monoxide, further fuelling global warming.

Any discussion of the background art throughout the specification should in no way be considered as an admission that such background art is prior art, nor that such background art is widely known or forms part of the common general knowledge in the field in Australia or any other country.

### SUMMARY OF THE INVENTION

The invention seeks to provide an organic carbonisation system which will overcome or substantially ameliorate at least some of the deficiencies of the prior art, or to at least provide an alternative.

According to a first aspect, the present invention may be said to involve an organic carbonisation system (OCS) for carbonizing of organic matter, the organic carbonisation system comprising:
a. a pressurisable reactor vessel, the reactor vessel being configured for receiving organic matter in use via an inlet and for heating received organic matter by heat transfer from heated working gas under pressure while feeding the received organic matter along a substantially hollow uninterrupted heating portion to an outlet;
b. a pressurised heating circuit including a circulation fan and a heating arrangement adapted for heating pressurised heating gas, the pressurised heating set circuit being adapted for moving the pressurised heating gas between the reactor vessel, circulation fan and heating arrangement;
c. an inlet feed valve configured for feeding organic matter into the reactor vessel via the inlet while the reactor vessel is under pressure, while maintaining pressure in the reactor vessel; and
d. an outlet feeder valve configured for feeding carbonised organic matter from the reactor vessel via the outlet while the reactor vessel is under pressure, while maintaining pressure in the reactor vessel.

In one embodiment, the reactor vessel is configured for feeding heated working gas into the reactor vessel at a bottom end of a heating portion.

In one embodiment, the reactor vessel is configured for feeding heated working gas into the reactor vessel at a bottom end of a heating portion at a heating inlet arrangement.

In one embodiment, the reactor vessel is configured for heating the organic matter under pressure using one or more selected from:
a. an uninterrupted fluidised bed arrangement; and
b. an uninterrupted packed bed arrangement.

According to a first aspect, the present invention may be said to involve an organic carbonisation system (OCS) for carbonizing of organic matter, the organic carbonisation system comprising:
a. a pressurisable reactor vessel, the reactor vessel being configured for receiving organic matter via an inlet and for heating received organic matter by heat transfer from heated working gas under pressure;
b. a pressurised heating circuit including a circulation fan and a heating arrangement adapted for heating pressurised heating gas, the pressurised heating set circuit being adapted for moving the pressurised heating gas between the reactor vessel, circulation fan and heating arrangement; and
c. an inlet feed valve configured for feeding organic matter into the reactor vessel via the inlet while the reactor vessel is under pressure, while maintaining pressure in the reactor vessel.

In one embodiment, the reactor vessel is configured for feeding heated working gas into the reactor vessel at a bottom end of a heating portion.

In one embodiment, the reactor vessel is configured for heating the organic matter under pressure using one or more selected from
a. a fluidised bed arrangement; and
b. a packed bed arrangement; and

In one embodiment, the inlet feed valve is one or more selected from
a. a rotary airlock valve; and
b. a trickle valve.

In one embodiment, the reactor vessel includes a heating portion in which organic matter is heated.

In one embodiment, the reactor vessel includes a cooling portion in which organic matter is cooled.

In one embodiment, the reactor vessel includes an intermediate portion located between the heating portion and the cooling portion.

In one embodiment, the cooling portion includes at least one or more cooling inlet arrangements for feeding cooling gas from the cooling circuit into the reactor vessel.

In one embodiment, the at least one or more cooling inlet arrangements are configured as an annular member.

In one embodiment, the at least one or more cooling inlet arrangements include a plurality of outlets for pressurised cooling gas from the cooling circuit.

In one embodiment, the reactor vessel includes at least one or more heating inlet arrangements for feeding heated gas from the heating circuit into the reactor vessel.

In one embodiment, the at least one or more heating inlet arrangements are configured as an annular member.

In one embodiment, the at least one or more heating inlet arrangements include a plurality of outlets for pressurised heating gas from the heating circuit.

In one embodiment, the reactor vessel includes an upper inlet end and a lower outlet end.

In one embodiment, the reactor vessel includes at least one heating inlet arrangement located substantially midway along its length.

In one embodiment, the reactor vessel includes a heating inlet arrangement located at or towards the lower outlet end.

In one embodiment, the cooling inlet arrangement is located at or towards the lower outlet end.

In one embodiment, the reactor vessel is elongate.

In one embodiment, the reactor vessel is oriented substantially vertically.

In one embodiment, reactor vessel includes one or more selected form a perforated gate valve and a perforated butterfly valve for restricting flow of organic matter through the reactor vessel.

In one embodiment, the reactor vessel includes an outlet feed valve.

In one embodiment, the outlet feed valve is one or more selected from:
a. a rotary airlock valve; and
b. a trickle valve.

In one embodiment, the OCS includes a cooling vessel.

In one embodiment, the outlet of the reactor vessel feeds into an inlet of the cooling vessel.

In one embodiment, the outlet feed valve feeds carbonised organic matter from the reactor vessel into the cooling vessel.

In one embodiment, the heating arrangement includes a heating heat exchanger.

In one embodiment, the heating arrangement includes a heating fan and a primary heat source.

In one embodiment, the primary heat source is powered by one or more selected from:
a. the combustion of hydrogen;
b. electrical heating;
c. focused sunlight;
d. the combustion of waste gases from the organic carbonisation system;
e. or any other suitable heating source.

In one embodiment, the heating fan is configured to feed air to the primary heat source, where it is heated, and onward to the heating heat exchanger.

In one embodiment, the heating arrangement includes a secondary heating heat exchanger.

In one embodiment, the secondary heating heat exchanger is configured for transferring heat received from the heating heat exchanger to air being fed to the heater.

In one embodiment, the OCS includes a cooling circuit.

In one embodiment, the cooling vessel includes at least one or more cooling inlet arrangements for feeding cooling gas from the cooling circuit into the reactor vessel.

In one embodiment, the at least one or more cooling inlet arrangements are configured as an annular member.

In one embodiment, the at least one or more cooling inlet arrangements include a plurality of outlets for pressurised cooling gas from the cooling circuit.

In one embodiment, the cooling circuit is pressurisable.

In an alternative embodiment, the cooling circuit is at ambient pressure.

In one embodiment, the OCS includes a heat transfer arrangement for transferring heat from the cooling circuit to the heating circuit.

In one embodiment, the heat transfer arrangement includes a heat exchanger.

In one embodiment, the cooling circuit includes a second heat transfer arrangement for removing heat from the cooling circuit.

In one embodiment, the second heat transfer arrangement includes a heat exchanger.

In one embodiment, the second heat transfer arrangement includes a cooling fan.

In one embodiment, the heated working gas has a reduced content of dioxygen.

In one embodiment, the organic carbonisation system further comprises a pressurisable first lock hopper located at the inlet to the reactor vessel, the lock hopper being pressurisable with the working gas.

In one embodiment, the organic carbonisation system further comprises a pressurisable second lock hopper located at an outlet of the cooling vessel, the second lock hopper being configured to be pressurised by the working gas and for receiving cooled carbonised organic waste and gas from the cooling vessel under pressure.

In an alternative embodiment, the organic carbonisation system further comprises a pressurisable second lock hopper located at an outlet of the reactor vessel, the second lock hopper being configured to be pressurised by the working gas and for receiving cooled carbonised organic waste and gas from the cooling portion of the reactor vessel under pressure.

In one embodiment, the organic carbonisation system includes a controller.

In one embodiment, the controller includes a processor operationally connected to digital storage media configured for storing data and/or software instructions.

In one embodiment, the OCS includes at least one or more sensors.

In one embodiment, the sensors include one or more selected from:
a. temperature sensors;
b. pressure sensors;
c. weight sensors;
d. airflow sensors;
e. or the like.

In one embodiment, the controller is configured to receive sensing signals from the sensors.

In one embodiment, the controller is configured to control the feed rate of the inlet feed valve in order to maintain the required temperatures along the length of the reactor vessel.

In one embodiment, the controller is configured to control the speed of the circulation fan on the heating circuit in order to maintain the required temperatures along the length of the reactor vessel.

In one embodiment, the heating arrangement.

In one embodiment, the heating arrangement includes a microwave heater.

In one embodiment, the microwave heater is configured for heating the organic matter in the reactor vessel directly.

According to a further aspect, the present invention may be said to involve an organic carbonisation system (OCS) for the carbonisation of a feed of organic matter in a continuous process, the carbonisation system comprising:
a. a reactor vessel defining at least a heating portion
b. a gas heating system adapted for heating one or more selected from pressurised heating gas and organic matter;
c. wherein the reactor vessel is adapted for receiving organic waste from a rotating feed valve and is configured for heating received organic waste in one or more selected from a packed bed and a fluidised bed.

In one embodiment, the gas heating system is configured for heating organic matter within the reactor vessel.

In one embodiment, the gas heating system includes a microwave heating system.

In one embodiment, the microwave heating system is configured for heating organic matter within the reactor vessel.

In one embodiment, the OCS includes a pressurised heating circuit adapted for guiding pressurised heating gas between the heating portion of the reactor vessel, a circulation fan and the gas heating system.

In one embodiment, the reactor vessel is adapted for heating the received organic matter by heat transfer from heated working gas.

In one embodiment, the reactor vessel is adapted for receiving organic waste in discrete portions from the rotating valve.

In one embodiment, the pressurised heating gas provides an oxygen deficient environment in the reactor vessel for the carbonisation of organic waste.

In one embodiment, the pressurised heating gas is inert.

In one embodiment, the reactor defines a cooling portion in which heated organic matter is cooled.

In one embodiment, the OCS further comprises a pressurised cooling circuit adapted for moving a pressurised cooling gas between
a. a cooling portion adapted for receiving hot carbonised organic waste from the pressurised heating circuit,
b. a circulation fan, and
c. a cooling heat exchanger adapted for cooling the pressurised cooling gas.

In one embodiment, the cooling circuit includes a first cooling heat exchanger and a second cooling heat exchanger.

In one embodiment, the first cooling heat exchanger is configured for transferring heat from the cooling circuit to the heating circuit.

In one embodiment, the second cooling heat exchanger is configured for cooling the cooling circuit from ambient air.

In one embodiment, a cooling fan is provided for blowing ambient air over the second cooling heat exchanger.

In one embodiment, the organic carbonisation system further comprises a first separator located on the pressurised heating circuit, the separator being configured for separating solid particles from the pressurised heating gas.

In one embodiment, the organic carbonisation system further comprises a second separator located on the pressurised cooling circuit, the separator being configured for separating solid particles from the pressurised cooling gas.

In one embodiment, the organic carbonisation system further comprises a pressurisable first lock hopper located at the inlet to the reactor vessel, the lock hopper being pressurisable with the working gas.

In one embodiment, the organic carbonisation system further comprises a pressurisable second lock hopper located at an outlet of the cooling vessel, the second lock hopper being configured to be pressurised by the working gas and for receiving cooled carbonised organic waste and gas from the cooling vessel under pressure.

In one embodiment, the organic carbonisation system further comprises a gas heating system configured for heating pressurised gas.

In one embodiment, the organic carbonisation system further includes a carbonisation reactor vessel including an inlet for receiving organic material into the carbonisation reactor vessel.

In one embodiment, the carbonisation reactor vessel further includes an inlet for receiving a heated gas from the heating circuit.

In one embodiment, the inlet is configured to pass heated gas to an underside of the one or more selected from the packed bed and the fluidised bed.

In one embodiment, the carbonisation reactor vessel further includes an outlet for the removal of carbonised organic matter.

In one embodiment, the carbonisation reactor vessel further includes a gas outlet for the removal of heated gas.

In one embodiment, the organic carbonisation system further includes a separator configured for separating carbonised organic matter and heated gas received from the outlet of the carbonisation reactor vessel.

In one embodiment, the separator is configured for receiving heated gas and carbonised organic matter from the gas outlet.

In one embodiment, the separator is configured for returning the separated carbonised organic matter to the carbonisation reactor vessel.

In one embodiment, the gas heating system comprises a heat exchanger.

In one embodiment, the organic carbonisation system includes passages between the carbonisation reactor vessel, the separator and the heat exchanger disposed in a closed circuit for the recirculation of the pressurised gas.

In one embodiment, the passages are configured to be pressurised.

In one embodiment, the gas heating system includes a primary heat source for heating the pressurised gas in the heat exchanger.

In one embodiment, the primary heat source is powered by one or more selected from:
a. the combustion of hydrogen;
b. electrical heating;
c. focused sunlight;
d. the combustion of waste gases from the organic carbonisation system;
e. or any other suitable heating source.

In one embodiment, the separator is a cyclonic separator.

In one embodiment, the outlet is closed by a rotary airlock valve.

In one embodiment, the organic carbonisation system further comprises a lock hopper at the carbonised organic waste outlet of the carbonisation reactor vessel.

In one embodiment, the separator is configured to direct separated heated gases to a pressure control valve.

In one embodiment, the separator is configured to direct separated heated gases to a flare stack.

In one embodiment, the organic carbonisation system further comprises a circulation pump for circulating the pressurised gas around the closed heating circuit.

In one embodiment, the circulation pump is a fan.

In one embodiment, the gas heating system includes a recuperator configured for transferring heat from fluids received from the heat exchanger to fluids being fed to the heat exchanger.

In one embodiment, the recuperator includes a heat exchanger.

In one embodiment, the organic carbonisation system further comprises an organic matter feed hopper.

In one embodiment, the organic matter feed hopper is a pressure vessel.

In one embodiment, the organic matter feed hopper is configured for feeding organic matter into the carbonisation reactor vessel.

In one embodiment, the organic matter feed hopper and carbonisation reactor vessel separated by a lock hopper.

In one embodiment, the organic carbonisation system further comprises a cooling system.

In one embodiment, the cooling system comprises a cooling chamber.

In one embodiment, the cooling system comprises a fluid cooling system.

In one embodiment, the cooling system comprises a separator configured for separating cooled carbonised organic waste from cooling fluid.

In one embodiment, the cooling chamber is a pressure vessel.

In one embodiment, the cooling chamber is at ambient pressure.

In one embodiment, the cooling chamber includes:
a. an inlet for receiving hot carbonised organic waste from carbonisation reactor vessel,
b. a bed of fine particles,
c. a cooling inlet for receiving a cool gas from the gas cooling system, the cooling inlet being configured to pass cooled gas to an underside of the bed.

In one embodiment, the bed of the cooling chamber is a fluidised bed.

In one embodiment, the cooling chamber includes an outlet for the removal of carbonised organic matter and heated gas from the cooling chamber.

In one embodiment, the cooling chamber includes a cooling circulation pump.

In one embodiment, the cooling circulation pump is a circulation fan.

In one embodiment, the cooling system comprises a cooling heat exchanger.

In one embodiment, the cooling system includes a pressurised cooling circuit extending between the cooling chamber, the cooling separator, a first cooling heat exchanger and the cooling circulation fan.

In one embodiment, the organic carbonisation system further includes a lock hopper at the outlet of the cooling chamber.

In one embodiment, the OCS includes a pre-heating arrangement.

In one embodiment the pre-heating arrangement is configured for using heat from the carbonised organic waste received from the reactor vessel to preheat the organic waste feed.

In one embodiment, the preheating arrangement includes a heat exchanger.

In one embodiment, the preheating arrangement includes a preheating conduit.

In one embodiment, the preheating conduit extends from the heat exchanger to the organic waste feed.

In one embodiment, the preheating arrangement includes a pump configured for pumping air along the preheating conduit as a preheating air stream.

In one embodiment, the preheating conduit may be a circuit.

In one embodiment, the heat exchanger is configured for exchanging heat between carbonised organic waste received from the reactor vessel and the preheating air stream.

In one embodiment, the heat exchanger is configured to exchange heat with carbonised organic waste in the cooling chamber.

In one embodiment, the heat exchanger is located at least partially within the second lock hopper.

In one embodiment, the preheating conduit is pressurised.

In one embodiment, the preheating conduit extends between the first lock hopper and the second lock hopper.

In one embodiment, the preheating conduit extends between the first lock hopper and the second lock hopper, and back to the first lock hopper.

In one embodiment, the preheating conduit extends from the heat exchanger in the cooling chamber to the organic matter feed hopper.

In one embodiment, the preheating conduit vents to atmosphere.

According to a further aspect, the invention may be said to involve a method of treating organic matter, the method comprising the steps of:
a. feeding organic waste into a pressurised reactor vessel at a constant feed rate
b. pressurising the organic waste in a carbonisation reactor vessel in an oxygen reduced environment;
c. heating the organic waste using a heating gas; and
d. cycling the heating gas through a pressurised heating circuit via a circulation pump and a heat exchanger to reheat the heating gas.

In one embodiment, the step of feeding organic waste into a pressurised reactor vessel at a constant feed rate includes the step of feeding it through one or more selected from:
a. a trickle valve; and
b. an airlock rotary valve.

In one embodiment, the step of feeding organic waste into a pressurised reactor vessel comprises the step of feeding the organic waste from a hopper at ambient pressure.

In one embodiment, the heating gas is dioxygen deficient.

In one embodiment, the method includes the step of:
a. cycling the heating gas through a separator to separate carbonised organic matter from the heating gas.

In one embodiment, the method includes the step of:
a. directing excess pressurised heating gas through a pressure regulating valve.

In one embodiment, the method includes the step of:
a. directing the reheated gas to one or more selected from a packed bed and a fluidised bed in the carbonisation reactor vessel

In one embodiment, the method includes the step of:
a. feeding organic waste into the carbonisation reactor via a lock hopper.

In one embodiment, the method includes the step of:
a. feeding carbonised organic waste organic waste into a cooling system.

In one embodiment, the method includes the step of:
a. feeding carbonised organic waste into a cooling system via an airlock rotary valve.

In one embodiment, the method includes the step of:
a. directing cooling gas through a bed of carbonised organic waste in the cooling system.

In one embodiment, the method includes the step of:
a. directing cooling pressurised gas through a bed of carbonised organic waste in the cooling system.

In one embodiment, the method includes the step of:
a. cycling the cooling gas through a pressurised cooling circuit via a circulation pump and a heat exchanger to cool the cooling gas.

In one embodiment, the method includes the step of:
a. transferring heat in the heated cooling gas to the heating circuit via the heat exchanger.

In one embodiment, the method includes the step of:
a. feeding carbonised organic waste into a cooling bin via an airlock rotary valve.

In one embodiment, the method includes the step of:
a. utilising a preheating arrangement to transfer heat from carbonised organic waste received from the carbonisation reactor vessel to organic waste feed to be fed to the carbonisation reactor vessel to preheat the organic waste feed.

According to a further aspect, the invention may be said to involve a control system configured for controlling an organic carbonisation system as described above to carry out the method steps as described above.

According to a further aspect, the invention may be said to involve an organic carbonisation system (OCS) for carbonizing of organic matter, the organic carbonisation system comprising:
a. a pressurisable reactor vessel, the reactor vessel being configured for receiving organic matter in use via an inlet and for heating received organic matter by heat transfer from heated working gas under pressure while feeding the received organic matter along a substantially hollow uninterrupted heating portion to an outlet;
b. a pressurised heating circuit including a circulation fan and a heating arrangement adapted for heating pressurised working gas, the pressurised heating circuit being adapted for moving the pressurised heated working gas between the reactor vessel, a circulation fan and a heating arrangement;
c. an inlet feed valve configured for feeding organic matter into the reactor vessel via the inlet while the reactor vessel is under pressure, while maintaining pressure in the reactor vessel; and
d. an outlet feeder valve configured for feeding carbonised organic matter from the reactor vessel via the outlet while the reactor vessel is under pressure, while maintaining pressure in the reactor vessel.

In one embodiment, the reactor vessel is configured for heating the organic matter under pressure using one or more selected from:
a. an uninterrupted fluidised bed arrangement; and
b. an uninterrupted packed bed arrangement.

In one embodiment, the reactor vessel is configured for feeding heated working gas into the reactor vessel at a bottom end of a heating portion at a heating inlet arrangement.

In one embodiment, the reactor vessel includes a cooling portion in which organic matter is cooled, wherein the cooling portion includes at least one or more cooling inlet arrangements for feeding cooling gas from the cooling circuit into the reactor vessel.

In one embodiment, the reactor vessel includes an intermediate portion located between the heating portion and the cooling portion in which a carbonisation is allowed to occur.

In one embodiment, the OCS includes a cooling vessel, and wherein the outlet of the reactor vessel feeds into an inlet of the cooling vessel.

In one embodiment, the heating arrangement includes a heating heat exchanger, a heating fan and a primary heat source.

In one embodiment, the heating arrangement includes a secondary heating heat exchanger configured for transferring heat received from the heating heat exchanger to air being fed to the heater.

In one embodiment, the OCS includes a cooling circuit.

In one embodiment, the cooling vessel includes at least one or more cooling inlet arrangements for feeding cooling gas from the cooling circuit into the reactor vessel.

In one embodiment, the cooling circuit is pressurisable.

In one embodiment, the cooling circuit is at ambient pressure.

In one embodiment, the OCS includes a heat transfer arrangement for transferring heat from the cooling circuit to the heating circuit.

In one embodiment, the cooling circuit includes a second heat transfer arrangement for removing heat from the cooling circuit.

In one embodiment, the organic carbonisation system further comprises a pressurisable first lock hopper located at the inlet to the reactor vessel, the lock hopper being pressurisable with the working gas.

In one embodiment, the organic carbonisation system further comprises a pressurisable second lock hopper located at an outlet of the cooling vessel, the second lock hopper being configured to be pressurised by the working gas and for receiving cooled carbonised organic waste and gas from the cooling vessel under pressure.

In one embodiment, the organic carbonisation system further comprises a pressurisable second lock hopper located at an outlet of the reactor vessel, the second lock hopper being configured to be pressurised by the working gas and for receiving cooled carbonised organic waste and gas from the cooling portion of the reactor vessel under pressure.

In one embodiment, the organic carbonisation system includes a controller, the controller including a processor operationally connected to digital storage media configured for storing data and/or software instructions.

In one embodiment, the OCS includes at least one or more sensors operationally connected to the controller, the sensors allowing the controller to monitor and control one or more selected from:
a. the temperature of the heating working gas;
b. the pressure of the heating working gas;
c. the heating effect of the heating arrangement;
d. the flow speed of the heated working gas in the heating circuit;
e. the flow speed of the cooling gas in the cooling circuit;
f. the feed rate of the inlet valve to the reactor vessel;
g. the feed rate of the outlet valve from the reactor vessel;
h. the feed rate of the outlet valve from the cooling vessel.

In one embodiment, the OCS includes at least one or more sensors operationally connected to the controller, the sensors allowing the controller for monitoring factors affecting the carbonisation reaction in the reactor vessel including one or more selected from:
a. the temperature of the heating working gas;
b. the pressure of the heating working gas;
c. the heating effect of the heating arrangement;
d. the flow speed of the heated working gas in the heating circuit;
e. the flow speed of the cooling gas in the cooling circuit;
f. the feed rate of the inlet feed valve to the reactor vessel; and

g. the feed rate of the outlet feeder valve from the reactor vessel.

In one embodiment, the controller is configured for controlling any of the factors affecting the carbonisation reaction to ensure that the organic matter is subjected to a combination of the following conditions in an oxygen-reduced environment for approximately 15-20 minutes or more:
i. a pressure of 3 bar (300 kPa) and 12 bar (1200 kPa); and
ii. temperatures in the range of 300° C.-500° C.

In one embodiment, the controller is configured for:
a. detecting a temperature increase in the reactor vessel due an exothermic reaction of carbonisation o the organic matter, and
b. adjusting the factors affecting the carbonisation reaction accordingly.

According to a further aspect, the invention may be said to involve an organic carbonisation system (OCS) for the carbonisation of a feed of organic matter in a continuous process, the carbonisation system comprising:
a. a pressurizable reactor vessel comprising an uninterrupted hollow vertical heating portion in which organic matter can be heated;
b. a gas heating system adapted for heating one or more selected from pressurised heating gas and organic matter;
c. wherein the reactor vessel is adapted for receiving organic waste from a rotating feed valve and is configured for heating received organic waste in one or more selected from a packed bed and a fluidised bed.

In one embodiment, the gas heating system is configured for heating organic matter within the reactor vessel by feeding heated gas in the bottom of the heating portion and retrieving the heated gas from the top of the heating portion.

In one embodiment, the gas heating system includes a microwave heating system.

In one embodiment, the microwave heating system is configured for heating organic matter within the reactor vessel.

In one embodiment, the OCS includes a pressurised heating circuit adapted for guiding pressurised heating gas between the heating portion of the reactor vessel, a circulation fan and the gas heating system.

In one embodiment, the reactor vessel defines a cooling portion in which heated organic matter is cooled.

In one embodiment, the OCS further comprises a pressurised cooling circuit adapted for moving a pressurised cooling gas between
a. a cooling portion adapted for receiving hot carbonised organic waste from the pressurised heating circuit,
b. a circulation fan, and
c. a cooling heat exchanger adapted for cooling the pressurised cooling gas.

In one embodiment, the cooling circuit includes a first cooling heat exchanger and a second cooling heat exchanger.

In one embodiment, the first cooling heat exchanger is configured for transferring heat from the cooling circuit to the heating circuit.

In one embodiment, the second cooling heat exchanger is configured for cooling the cooling circuit from ambient air.

In one embodiment, the organic carbonisation system further comprises a cooling system.

In one embodiment, the cooling system comprises a cooling chamber.

In one embodiment, the cooling system comprises a fluid cooling system.

In one embodiment, the cooling chamber is a pressure vessel.

In one embodiment, the cooling system includes a pressurised cooling circuit extending between the cooling chamber, a first cooling heat exchanger and a cooling circulation fan.

In one embodiment, the OCS includes a pre-heating arrangement.

In one embodiment, the pre-heating arrangement is configured for using energy in the hot carbonised organic waste received from the reactor vessel to preheat one or more selected from:
a. the organic waste feed; and
b. the pressurised heating gas of the heating system.

According to a further aspect, the invention may be said to involve a method of treating organic matter, the method comprising the steps of:
a. feeding organic waste into a pressurised reactor vessel at an upper inlet using one or more selected from:
   i. a trickle valve; and
   ii. an airlock rotary valve;
b. heating the organic waste in an uninterrupted vertically oriented hollow heating portion of the reactor vessel using a pressurized dioxygen-reduced heating gas to cause the organic waste to carbonise;
c. feeding the carbonised organic waste out a lower outlet to cause the carbonising organic waste to move downwardly along the reactor vessel; and
d. cycling the heating gas through a pressurised heating circuit via a circulation pump and a heat exchanger to reheat the heating gas.

In one embodiment, the method includes the step of:
a. directing the reheated heating gas to a lower end of the heating portion and retrieving heating gas from the reactor vessel at an upper end of the heating portion.

In one embodiment, the method includes the step of:
a. directing the reheated heating gas to the underside of one or more selected from a packed bed and a fluidised bed of organic matter in the carbonisation reactor vessel.

In one embodiment, the method includes the step of:
a. feeding carbonised organic waste organic waste into a cooling portion.

In one embodiment, the method includes the step of:
a. directing cooling gas through a bed of carbonised organic waste in the cooling portion.

In one embodiment, the method includes the step of:
a. directing pressurised cooling gas through a bed of carbonised organic waste in the cooling system.

In one embodiment, the method includes the step of:
a. cycling the cooling gas through a pressurised cooling circuit via a circulation pump and a heat exchanger to cool the cooling gas.

In one embodiment, the method includes the step of:
a. transferring heat in the heated cooling gas to the heating circuit via the heat exchanger.

In one embodiment, the method includes the step of:
a. utilising a preheating arrangement to transfer heat from carbonised organic waste received from the carbonisation reactor vessel to organic waste feed to be fed to the carbonisation reactor vessel to preheat the organic waste feed.

According to a further aspect, the invention may be said to involve a method of controlling the carbonisation of organic matter in an organic carbonisation system, the method being carried out on an electronic device and including the steps of:
a. providing an organic carbonisation system as described above;
b. monitoring factors affecting the carbonisation reaction including one or more selected from:
   i. the feed rate of organic matter into a reactor vessel;
   ii. the feed rate of carbonised organic matter from the reactor vessel;
   iii. the pressure of heated working gas in the reactor vessel;
   iv. the flow rate of heated working gas through the reactor vessel;
   v. the temperature of heated working gas in the reactor vessel;
   vi. the flow rate of fuel to a heating system for heating the working gas; and
   vii. the flow rate of electrical power to a heating system for heating the working gas;
c. controlling any of the factors affecting the carbonisation reaction to ensure that the organic matter is subjected to a combination of the following conditions in an oxygen-reduced environment for approximately 15-20 minutes or more:
   i. a pressure of 3 bar (300 kPa) and 12 bar (1200 kPa); and
   ii. temperatures in the range of 300° C.-500° C.

In one embodiment, the method includes the step of:
a. detecting a temperature increase in the reactor vessel due an exothermic reaction of carbonisation o the organic matter, and
b. adjusting the factors affecting the carbonisation reaction accordingly.

In this specification, the term “oxygen-reduced” or “oxygen reduced” is intended to mean reference an environment in which the amount of dioxygen on the environment is reduced from that of normal air, and preferably between no oxygen and up to about 10% of the typical amount of dioxygen in air.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 shows a schematic view of a first embodiment of an organic carbonisation system;

FIG. 2 shows a perspective view of a first embodiment of an inlet arrangement;

FIG. 3 shows a perspective view of a second embodiment of an inlet arrangement;

FIG. 4 shows a schematic view of a second embodiment of an organic carbonisation system;

FIG. 5 shows a schematic view of a third embodiment of an organic carbonisation system;

FIG. 6 shows a schematic view of a fourth embodiment of an organic carbonisation system;

FIG. 7 shows a first embodiment of a method of carbonising organic matter;

FIG. 8 shows a second embodiment of a method of carbonising organic matter;

FIG. 9 shows a schematic view of a fifth embodiment of an organic carbonisation system;

FIG. 10 shows a schematic view of a sixth embodiment of an organic carbonisation system;

FIG. 11 shows a schematic view of a seventh embodiment of an organic carbonisation system;

FIG. 12 shows a schematic view of an eighth embodiment of an organic carbonisation system; and

FIG. 13 shows an embodiment corresponding to FIG. 10 without the perforated butterfly or gate valve.

### DESCRIPTION OF EMBODIMENTS

It should be noted in the following description that like or the same reference numerals in different embodiments denote the same or similar features.

### OCS

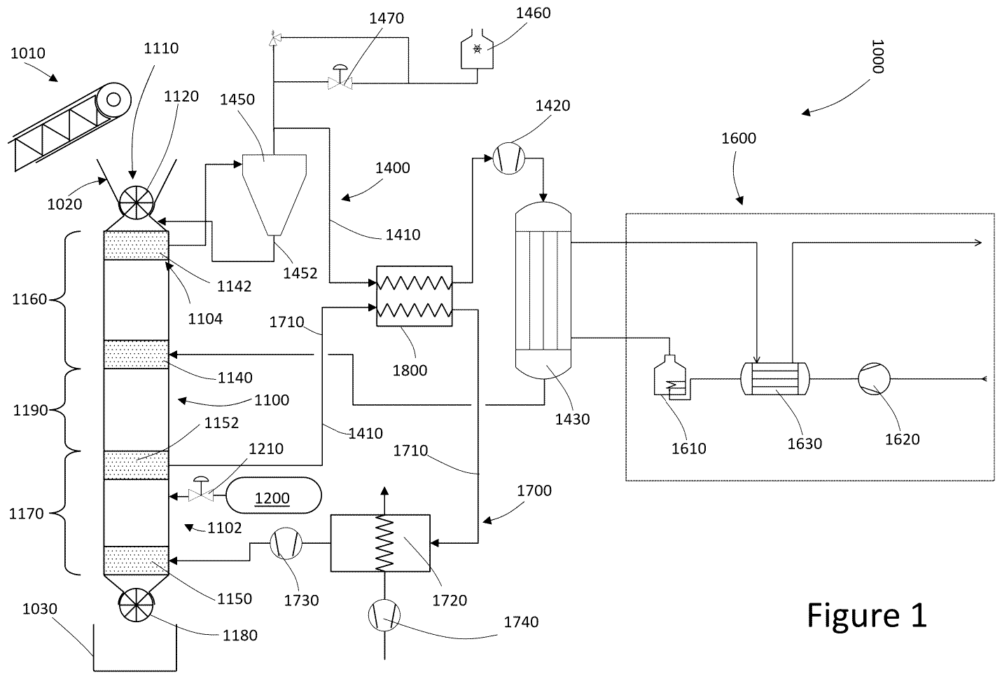

In a first embodiment shown in FIG. 1, there is provided an organic carbonisation system (OCS) 1000 for carbonising of organic matter. The OCS 1000 includes a pressurised reactor vessel 1100, a heating circuit 1400 and a cooling circuit 1700.

The reactor vessel 1100 is fed with organic matter such as organic waste by feed conveyor 1010, which feeds the organic waste into feed hopper 1020.

The reactor vessel 1100 is preferably shaped like a vertically oriented elongated cylinder, including a lower end 1102 and an upper end 1104. The reactor vessel 1100 is adapted to receive organic matter and settle it within the reactor vessel from the lower end 1102 in a porous packed bed and/or fluidised bed. The reactor vessel includes an inlet feeder valve 1120 that is configured for feeding organic matter into the top of the reactor vessel 1100, and an outlet feeder valve 1180 that is configured for feeding carbonised organic matter out of a bottom end of the reactor vessel 1100, preferably into cold waste bin 1030. The inlet feeder valve 1120 and the outlet feeder valve 1180 are preferably configured as rotary airlock valves and/or trickle valves that allow a pressure difference to be maintained between the inside of the reactor vessel and the atmosphere while continuously and/or regularly feeding discrete portions of preferably pelletised organic matter or carbonised organic matter through the valves at regular intervals without having to refill lock hopper's or the like at the inlet and/or outlet to the reactor vessel (or less frequently). In this way, the carbonisation of organic matter can be treated in a continuous process or almost continuous process having a constant feed rate, as opposed to a batch process in which the pressure and/or temperature within the reactor vessel is lost and needs to be built up in a time-consuming process.

Organic matter settling within the reactor vessel in a porous packed bed and/or fluidised bed will be moved continuously downwardly as the outlet feeder valve 1180 continuously removes carbonised organic matter from the lower end of the reactor vessel 1100. Preferably, the rate of removal of the carbonised organic matter by the outlet feeder valve 1180 will be controlled by a controller 1900, together with the pressure and/or temperature and airflow within the heating circuit 1400 and cooling circuit 1700 to ensure that the organic matter is heated to a temperatures in the range of 300° C.-500° C., and at a pressure of between 3 bar and 10 bar in an oxygen deficient environment for approximately 15-20 minutes or more. Under these conditions, it is envisaged that the solid component of organic waste can be converted to between 93% and 99% carbon, depending on the type of organic waste input.

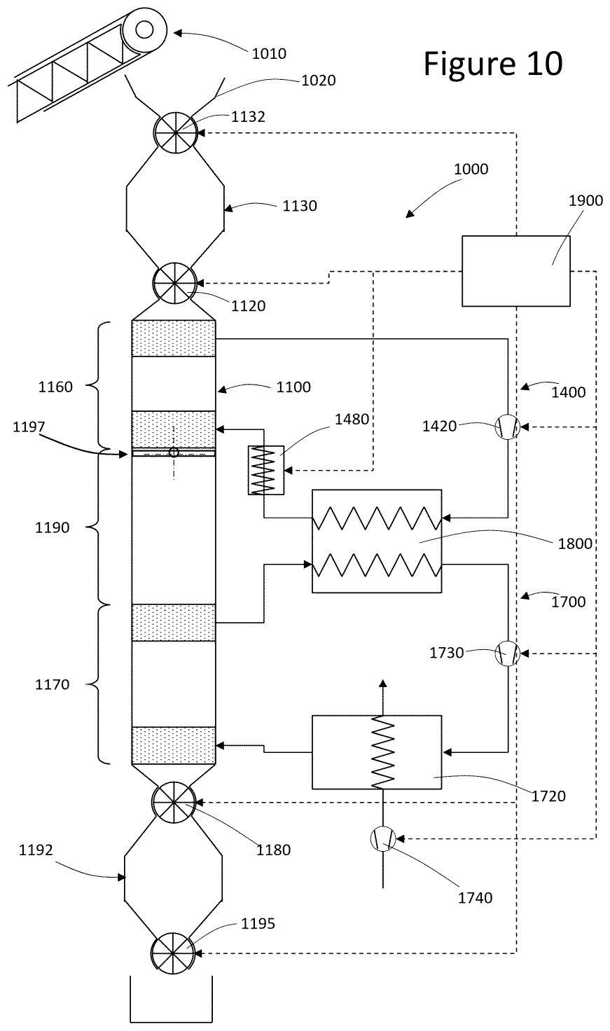

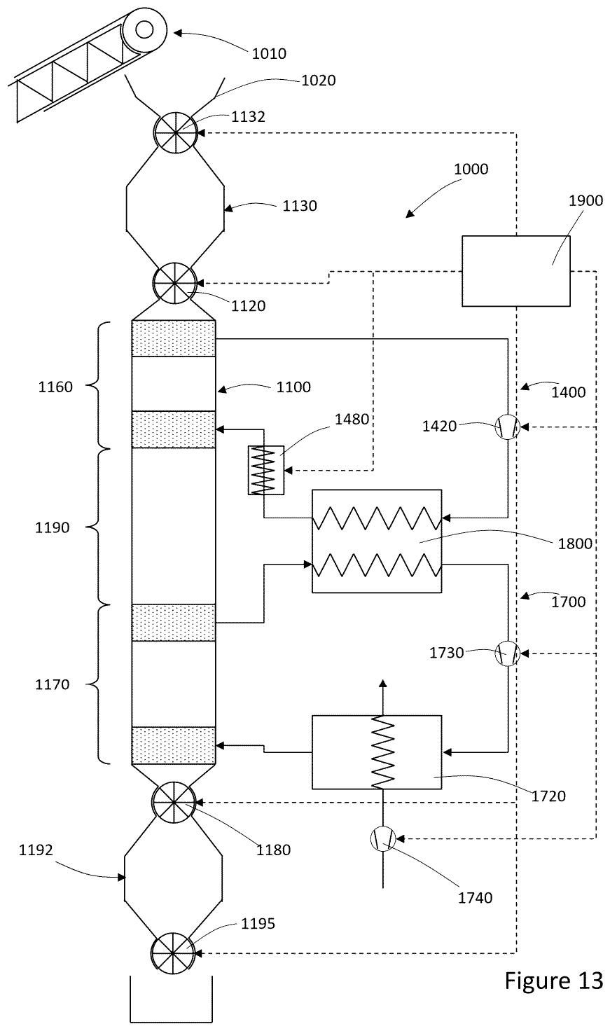

A perforated gate valve (not shown) or perforated butterfly valve (shown in FIG. 10) may be provided towards the centre of the length of the reactor vessel in order to support organic matter initially received into the reactor vessel for it to be carbonised before dropping it through into the cooling chamber. This would be useful on start-up. Alternatively, with reference to FIG. 13, no such butterfly valve may be provided and the first non-carbonised portion that drops straight through into the cooling portion on start-up could simply be recycled back into the reactor vessel once the process is up to temperature and is operating properly. In this embodiment, the reactor vessel would constitute an uninterrupted or unobstructed continuous length of hollow vessel that has no moving parts and nowhere for the organic matter to get caught on (except for the inlet and outlet rotary valves). Applicant believes that such an uninterrupted pathway will be preferable and will allow for a more streamlined process flow. In addition, applicant believes that this has important connotations for the effectiveness of the control of the process as will be described below.

In any of the embodiments, at least the heating portion is unobstructed, and/or uninterrupted and/or and continuously hollow. In other embodiments, it is envisaged that the heating portion and the intermediate portion (in which the organic matter has been heated to the correct temperature and pressure is allowed to carbonise without further direct heating from the OCS) can be uninterrupted and/or unobstructed and/or continuously hollow. In further embodiments, it is envisaged that the heating portion, intermediate portion and cooling portions may be unobstructed and/or uninterrupted and/or continuously hollow.

The heating circuit 1400 includes a circulation pump 1420, and a heating heat exchanger 1430 connected by passages 1410 in a heating circuit 1400. The OCS further includes a separator 1450, preferably in the form of a cyclonic separator, for removing small airborne particles of carbonised organic waste matter from the heating gas in the heating circuit 1400 coming from the reactor vessel 1100. Alternative types of separators are also envisaged, as will be apparent to persons skilled in the art. Such airborne particles will preferably be returned to the reactor vessel by passage 1452.

The heating circulation pump 1420, preferably in the form of a circulation fan, serves to pump the pressurised heating gas around heating circuit 1400 to keep it moving. It is envisaged that the velocity of the heating gas around the heating circuit 1400 can be controlled by the circulation fan.

The heating heat exchanger 1430 is adapted for receiving hot fluid from a heating system 1600, and transferring the heat in the hot fluid to the heating gas in the heating circuit 1400. The heated heating gas is then returned to the reactor vessel 1100 via heating inlet arrangements located within the reactor vessel 1100.

The heating system 1600 for heating the fluid to be sent to the heating heat exchanger preferably includes a primary heat source 1610, preferably in the form of a furnace. The furnace may be powered by combustion of hydrogen, or from other waste heat sources, biofuels, and/or fuels. The furnace may be powered by secondary process and/or waste heat utilisation, such as that from a solid oxide fuel cell. The furnace may be at least partly powered by combustion of volatile gases being given off by the carbonisation of the organic matter in the reactor vessel. Alternative primary heat sources such as electrical elements powered by preferably green electricity from photovoltaics and/or wind power, preferably coupled with Hydro and/or battery storage are also envisaged, as well as solar heating, for example heating by a solar concentrator with or without thermal storage.

The heating system 1600 further includes a fluid supply pump 1620 for pumping a fluid such as air or oxygen to the primary heat source 1610 where it may be combusted with a fuel to generate heat and passed to the heating heat exchanger 1430 as a heated. It is envisaged that the fluid passing through the primary heat source 1610 will preferably be a fluid that has the required thermal properties for efficient heat transfer of heat from the heated fluid to the oxygen deficient fluid in the closed heating circuit within the heating heat exchanger 1430. The heating system 1600 further includes a recuperator 1630 in the form of a heat exchanger that allows energy in the previously heated fluid returning from the heating heat exchanger 1430 to preheat fluid moving towards the primary heat source 1610 from the pump 1620.

In an alternative embodiment as will be described in more detail below, it is envisaged that a primary heat source, for example in the form of a burner and/or element, may directly heat the heating heat exchanger and/or the heating circuit.

Additional heating gas can be introduced into the heating circuit 1400 via a pressure regulation inlet valve 1210 into the reactor vessel and/or heating circuit and/or cooling circuit from a working gas supply, preferably in the form of a pressurised tank 1200. The pressure regulation inlet valve 1210 is preferably controllable by the controller 1900.

The reactor vessel 1100 is configured for receiving organic matter via an organic matter inlet 1110 and for heating the received organic matter by heat transfer from a heated working gas under pressure. The heated working gas is a dioxygen deficient gas, and is preferably one or more selected from:
a. nitrogen;
b. any inert gas such as noble gases;
c. carbon dioxide;
d. or any other suitable gas

In the embodiment shown in FIG. 1, and as mentioned above the reactor vessel 1100 includes both a heating portion 1160 that corresponds loosely to the top half of the reactor vessel 1100, and a cooling portion 1170 that corresponds loosely to the lower half of the reactor vessel. An intermediate portion 1190 is provided between the heating portion 1160 and the cooling portion 1170, although this need not necessarily be the case. Preferably, the intermediate portion 1190 will be located within the reactor vessel 1100.

Heated heating gases from the heating circuit 1400 are fed into the reactor vessel via a heating inlet arrangement 1140, as will be described in more detail below, at a bottom end of the heating portion 1160 along the reactor vessel 1100. The heated heating gas rises from where it is introduced into the reactor vessel towards the inlet feeder valve 1120. The heated heating gas is then removed from the reactor vessel 1100 via heating outlet 1142, preferably at a top end 1164 of the heating portion 1160, to be fed to the separator 1450 and reheated in the heating circuit 1400. Reheated working gas is then fed back into the reactor vessel 1100 at the bottom end 1162 of the heating portion 1160.

The OCS shown in FIG. 1 further includes a cooling circuit 1700. The cooling circuit 1700 is configured for removing heat from the carbonised organic matter in the cooling portion 1170 of the reactor vessel 1100.

The cooling circuit includes passages 1710 that extend from the reactor vessel to a recuperation heat exchanger 1800, onward to a cooling pump 1730, but onward to a cooling heat exchanger 1720 and back to the reactor vessel 1100. The cooling pump 1730 pumps pressurised working gas in an endless circuit to cool the carbonised organic matter.

Hot pressurised working gas that is received from a cooling outlet arrangement in the reactor vessel is fed to the recuperation heat exchanger 1800. The recuperation heat exchanger 1800 is arranged to transfer heat from the working gas in the cooling circuit 1700 to the working gas in the heating circuit 1400 that has been received from the separator 1450. In this way, working gas in the heating circuit is preheated before being fully heated by the heating heat exchanger 1430, while the working gas in the cooling circuit is cooled. From the recuperation heat exchanger 1800, the cooled working gas is fed to the cooling heat exchanger 1720, and on to the cooling pump 1730. The cooling heat exchanger 1720 is preferably cooled by a cooling fan 1740 that drives cold ambient air over the cooling heat exchanger 1720, to thereby cause it to transfer from the working gas in the cooling circuit to the ambient air.

From the cooling pump 1730, the cooled working gas is transferred back to the reactor vessel 1700 where it is pumped into the lower end of the cooling portion 1170 at a cooling inlet arrangement 1150. The cooled working gas then moves up the cooling portion 1170 of the reactor vessel 1100, absorbing heat from the carbonised organic matter, until it is extracted from the cooling portion at a cooling outlet 1152, preferably located at a top end 1174 of the cooling portion 1170, to be circulated through the cooling circuit 1700 again.

It should be noted that both the heating circuit and the cooling circuit are pressurised in this embodiment, and that the same working gas is used. However, this need not necessarily be the case. In alternative embodiments, an unpressurised circuit may be used, or a less pressurised circuit. Further, air or any other gas can be used as the cooling fluid.

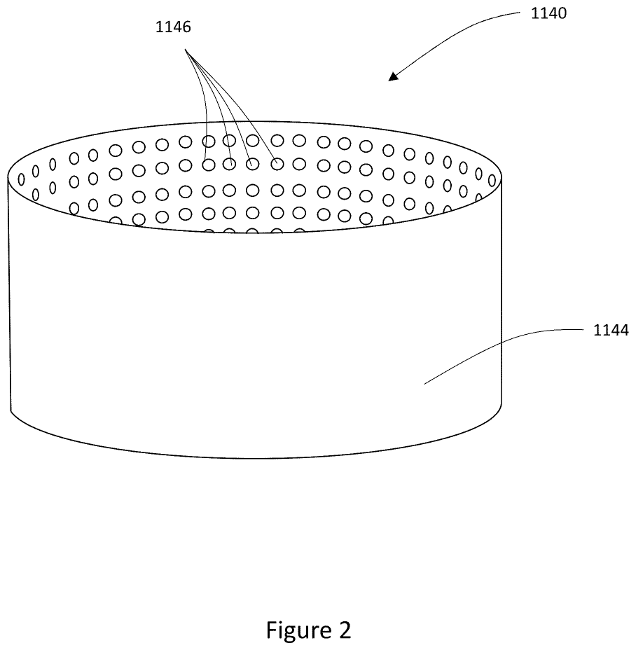

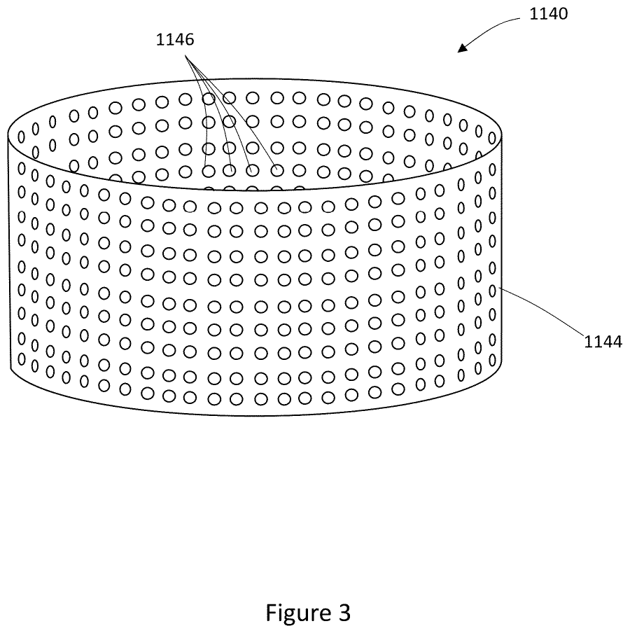

Now referring to FIGS. 2 and 3, a heating inlet arrangement 1140 is shown. It is envisaged that the heating inlet arrangement 1140 will preferably be provided in the form of a perforated hollow toroidal or annular body 1144 that is located within the reactor vessel. The hollow annular body 1144 is in fluid communication with the heating circuit 1400, in that heating fluid in the heating circuit is circulated via the hollow annular body 1144.

In the embodiment shown in FIG. 2, perforations 1146 are provided on an inner surface of the annular body 1144. In the embodiment shown in FIG. 2, the perforated annular body will extend around and about with an inner cylindrical surface of the reactor vessel 1100. Heating gas will be introduced into the annular body 1144 from the heating circuit and exit into the reactor vessel 1100 via the holes/perforations on the inner surface of the annular body. In this way, heating gas can be evenly introduced into the organic matter.

In the embodiment shown in FIG. 3, the heating inlet arrangement 1140 includes perforations and/or holes on both an inner and outer surface of the annular body 1144. It is envisaged that in this embodiment, the outer diameter of the annular body 1144 will be smaller than the internal diameter of the reactor vessel 1100, and the annular body will be supported within the reactor vessel in fluid communication with the heating circuit. Heated working gas from the heating circuit will be passed into the annular body 1144 and travel out through the holes and/or perforations 1146 on the outer and inner surfaces of the annular body 1144. In this way it is envisaged that heating gas can be more evenly spread through the preferably pelletised organic matter, and create an even heating effect.

It is envisaged that cooling inlet arrangement 1150 may be provided having similar features as the heating inlet arrangement 1140, but instead the cooling inlet arrangement will be in fluid communication with the cooling circuit 1700 and used for evenly distributing cooling working gas into the reactor vessel at the bottom of the cooling portion 1170 and/or removing cooling working gas from the reactor vessel at the top of the cooling portion.

Excess gases, and especially volatile gases may be retrieved from the separator 1450 and fed to a flare stack 1460. Further, excess pressure in the heating circuit may be regulated by regulator valve 1470.

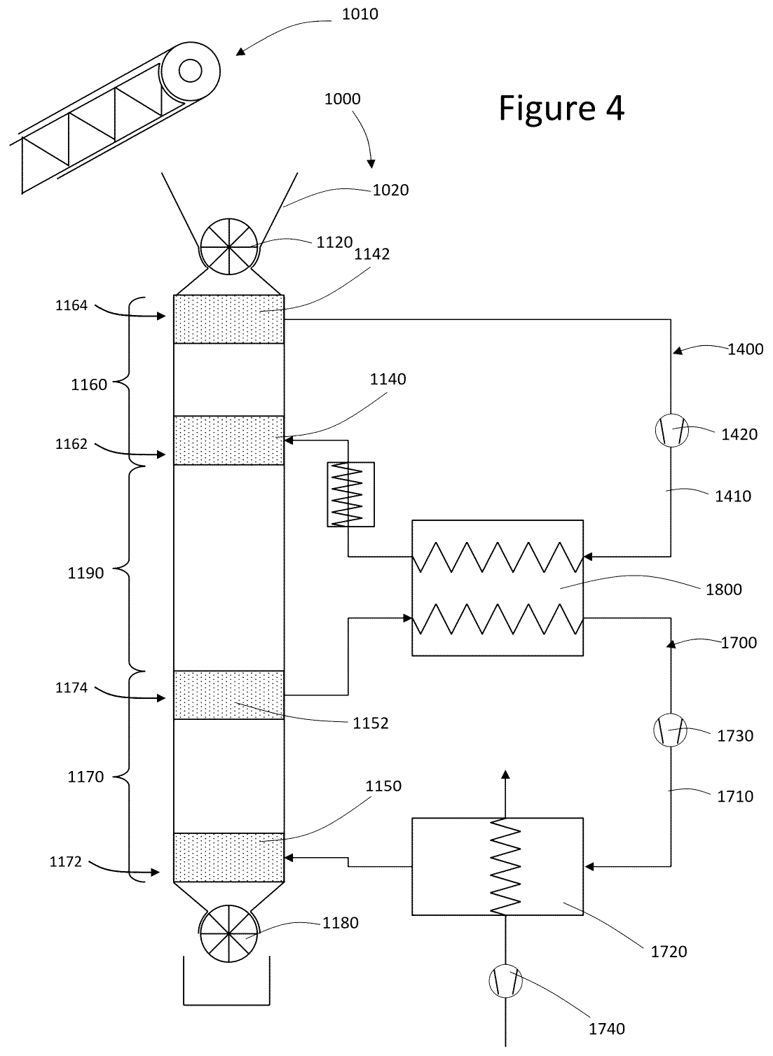

Another embodiment of an organic carbonisation system is shown in FIG. 4. This embodiment is very similar to the embodiment shown in FIG. 1 and differs only in that a heating element 1480 is provided directly within the heating circuit for heating the working gas, instead of heating system 1600.

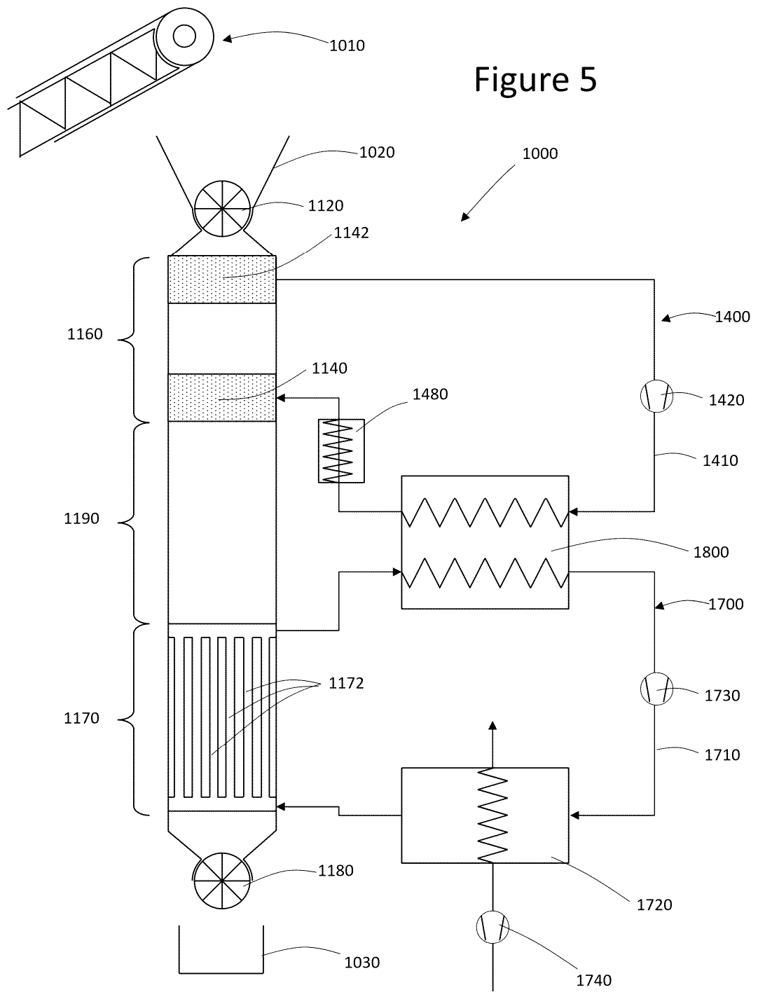

Another embodiment of an organic carbonisation system is shown in FIG. 5. This embodiment is similar to the embodiment shown in FIG. 4, however in this embodiment, the cooling portion includes a plurality of hollow vertically aligned fins 1176 that extend substantially along the vertical length of the cooling portion 1170. In this embodiment, cooling gas such as air passes through the cooling circuit and up through the hollow vertically aligned fins without mixing with the heating gas. This means that less heating gas can be used, and there is no mixing of cooling gasses with heating gasses within the reactor vessel 1100, which can affect temperatures in the intermediate portion 1190 and heating portion 1160.

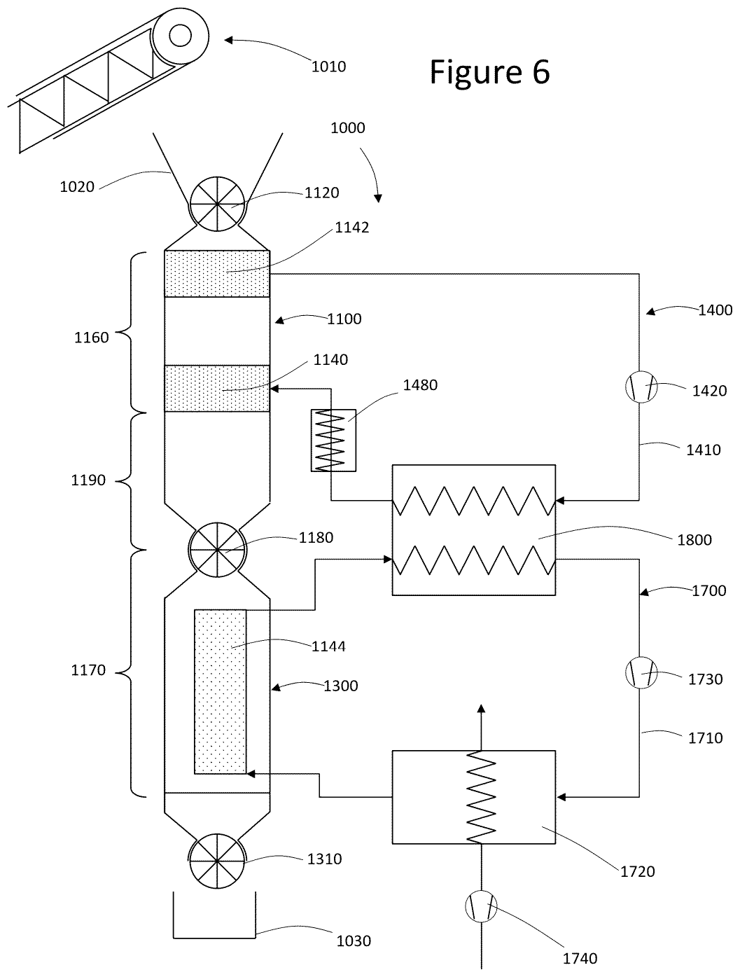

Another embodiment of an organic carbonisation system 1000 is shown in FIG. 6. In this embodiment, the reactor vessel is used purely for heating, after which carbonised organic matter is fed into a cooling vessel 1300. The cooling vessel 1300 and cooling circuit 1700 may be pressurised similarly to the reactor vessel, or alternatively, the cooling vessel 1300 may be unpressurised or close to ambient pressure. Feeder valves 1310, preferably in the form of rotary airlock valves and/or trickle valves, are provided between the reactor vessel 1100 and the cooling vessel 1300. Similarly, feeder valves may be provided from an outlet of the cooling vessel to a cold waste bin. Such feeder valves may be rotary airlock valves and/or trickle valves, depending on whether the cooling vessel 1300 and cooling circuit is pressurised.

In the embodiment shown in FIG. 6, an inlet arrangement comprising an extended hollow annular perforated body is provided that extends substantially along the full length of the cooling vessel 1300. Cooled air is pumped into the hollow annular perforated body from the cooling circuit, where it escapes through the perforations into the hot carbonised organic matter. As the carbonised organic matter moves downwardly along the cooling vessel 1300, it will be further cooled until by the time it is fed by cooling vessel outlet feeder valve 1310 out of the cooling vessel 1300, it will be at a relatively safe and manageable temperature. Preferably the cooling vessel outlet feeder valve 1310 is also one or more selected from a rotary airlock valve and/or a trickle valve.

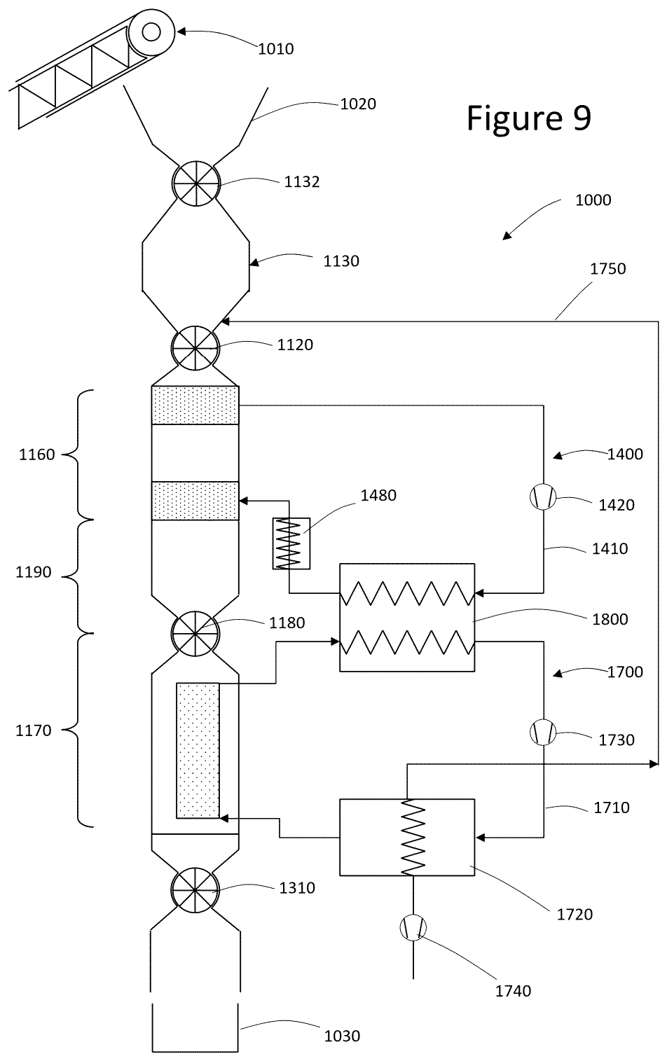

A further embodiment of an organic carbonisation system 1000 is shown in FIG. 9. This embodiment is similar to the embodiment shown in FIG. 6, and differs in that a lock hopper 1130 is provided underneath the feed hopper 1020, and before the reactor vessel 1100. The lock hopper 1130 is fed by a lock hopper feeder valve 1132, preferably in the form of a trickle valve and/or a rotary airlock valve. Further, air passing through the cooling heat exchanger 1720 that has absorbed heat from the cooling gas in the cooling circuit is routed via preheating passage 1750 to the lock hopper 1130, where the heated air is used to preheat the organic matter in the lock hopper. In this way, organic matter is preheated before entering the reactor vessel, enabling it to be brought up to temperature more quickly.

A further embodiment of an organic carbonisation system 1000 is shown in FIG. 10. In this embodiment, an outlet lock hopper 1192 is also provided at the outlet, however an inlet lock hopper 1130 is provided at the entry to the reactor vessel, while a further outlet lock hopper 1192 is provided at the outlet to the reactor vessel 1100. Preferably the inlet lock hopper 1130 is provided with a lock hopper feeder valves 1132 in the form of a rotary airlock valve, while the outlet lock hopper 1192 is provided with an outlet feeder valve 1195 in the form of one or more selected from a rotary airlock valve and a trickle valve.

It is envisaged that in the embodiment shown in FIG. 10, the provision of the inlet lock hopper 1130 and outlet lock hopper 1192 will assist in maintaining pressures within the reactor vessel, and result in less loss of pressurised working gas.

It is envisaged that in an alternative embodiment, an outlet lock hopper may similarly be provided at an outlet of a cooling vessel 1300 similar to that shown in FIG. 10.

In alternative embodiments (not shown) it is envisaged that the cooling circuit may be provided with a separator similar to the heating circuit, in order to remove small particles of carbonised organic matter such as ash from the cooling circuit airflow. Such small particles may cause wear on the cooling circuit pump.

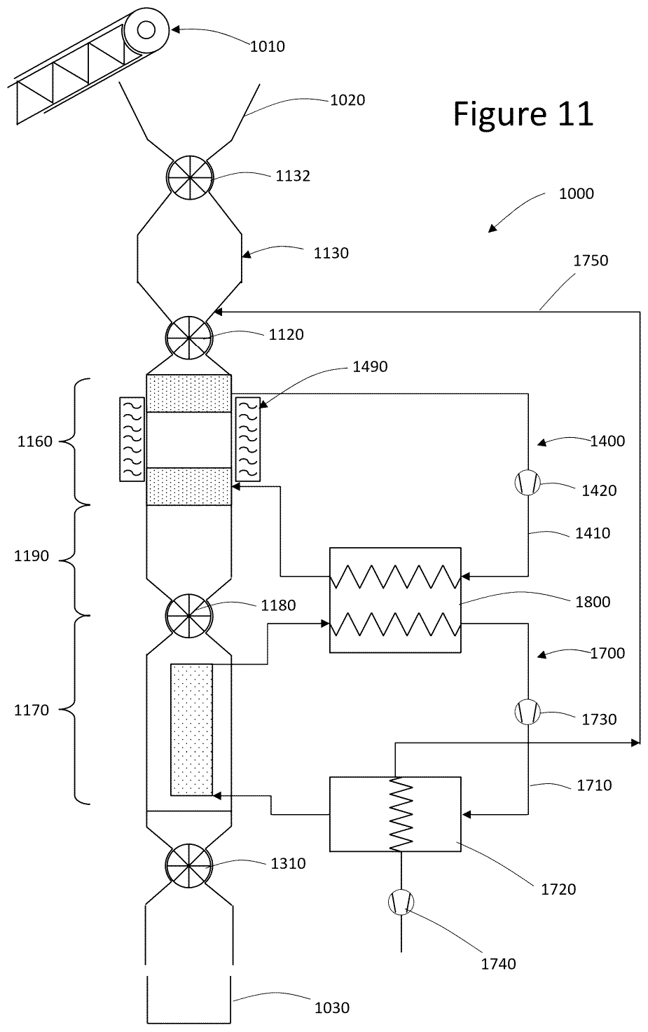

Another embodiment of an organic carbonisation system is shown in FIG. 11. In this embodiment, a microwave heater 1490 is provided that heats the organic matter within the reactor vessel directly. A heating circuit 1400 is still provided for guiding pressurised heating gas in an endless circuit as this allows for heat transfer from the cooling circuit to the heating circuit, increasing the efficiency of the OCS. In this embodiment, the heating circuit does not include a primary heat source for heating the heating gas as the microwave heater provides this heating input. This embodiment further includes a preheating arrangement wherein hot air from the heat exchanger 1720 is used to preheat the organic matter before being received into the reactor vessel.

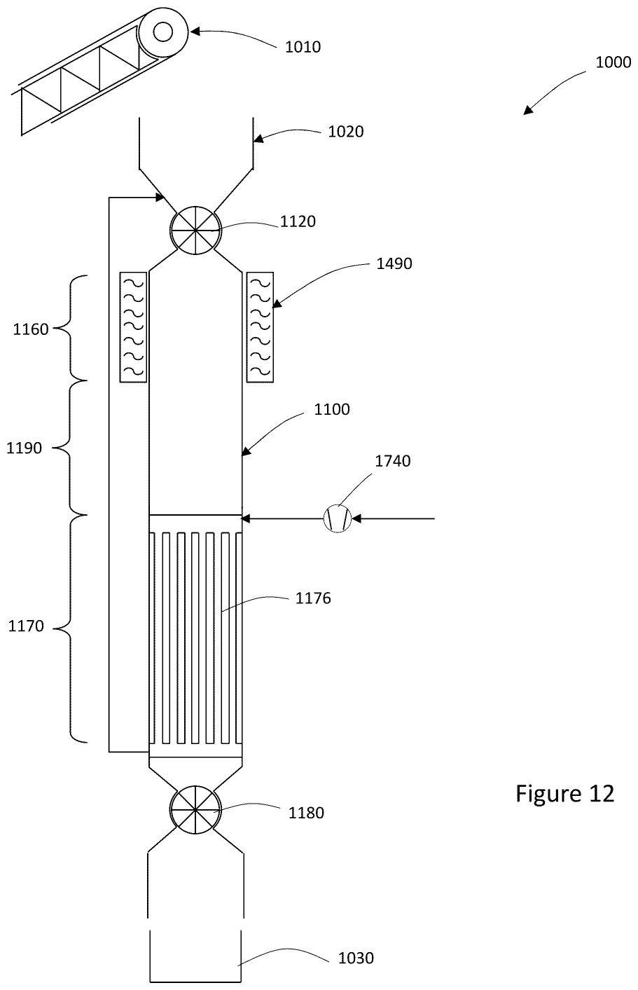

In a further embodiment shown in FIG. 12, no heating circuit is provided. Instead a microwave heater 1490 is used to heat the organic matter within the reactor vessel 1100 directly at a heating portion 1160. As the organic matter settles down beneath the level of the microwave heater 1490, it will be kept at pressure and remain within the required temperatures in the intermediate portion 1190. Once the organic matter has been sufficiently carbonised, it will be cooled in the cooling portion 1170. A cooling arrangement including a cooling passage or cooling circuit 1700 is provided for cooling the carbonised organic matter in the cooling portion 1170. In this embodiment, the cooling passage or cooling circuit 1700 is not an endless cooling circuit. Instead, a cooling fan 1740 is used to push air through a cooling heat exchanger 1720 (preferably including cooling fins similar to those described with reference to FIG. 5) within the cooling portion of the reactor vessel 1100. Heat is absorbed by the air in the cooling heat exchanger 1720 and is fed out of the cooling heat exchanger 1720 to the bottom of feed hopper 1020, where it is used to preheat the organic matter being fed into the reactor vessel 1100. Cooled carbonised organic matter is fed out of outlet rotary feeder valve 1180 into a cold waste bin 1030.

Whether the cooling portion is included as part of the reactor vessel, or whether a separate cooling vessel is provided, the organic matter is preferably controlled to move gradually downwardly through the heating portion where the organic matter is heated, and onward to the intermediate portion where the heated organic matter is retained at the requisite pressures and within the required temperature ranges for a requisite time period in order to carbonise the organic matter, after which the carbonised organic matter is fed through the cooling portion in order to cool the carbonised organic matter. The organic matter itself forms a bed of organic matter that may be a packed bed that moves gradually downwardly, or may be a fluidised bed or semi-fluidised bed at least within the heating portion and/or cooling portion.

The controller 1900 may include a processor (not shown) and a digital storage media (not shown) configured for storing data and/or software instructions for directing the processor to control any of the pumps, elements, feeder valves and/or control valves, conveyor belts or the like, and to receive sensor signals from sensors, including temperature sensors, pressure sensors, airflow sensors, force sensors, or the like that may be provided for ensuring that the heating process described is followed. The controller 1900 may further be provided with a transceiver for sending control signals to the components described above.

For example, the controller may be configured to control the feed rate of the inlet feed valve in order to maintain the required temperatures along the length of the reactor vessel. Further, the controller may be configured to control the feed rate of the outlet feeder valve from the reactor vessel in order to maintain the required temperatures along the length of the reactor vessel to ensure that the organic matter is subjected to the requisite temperatures for a minimum time period at a given pressure.

In another example, the controller 1900 may be configured to control the speed of the heating circulation pump 1420 on the heating circuit in order to increase and/or decrease the rate of heat transfer to the organic matter. Similarly, the controller may be configured to control the speed of the cooling circuit pump 1730 in order to increase and/or decreased the rate of heat transfer from the carbonised organic matter.

It is envisaged that organic matter will have been heated to the required temperatures by the time it moves below the heating inlet arrangement 1140 and will maintain the required temperature as it moves downwardly through the intermediate portion 1190 towards the cooling portion 1170. By the time that the organic matter reaches the top of the cooling portion 1170, it will have been maintained at the requisite temperatures and pressures for the required amount of time to carbonise the organic waste.

### Method of Treating

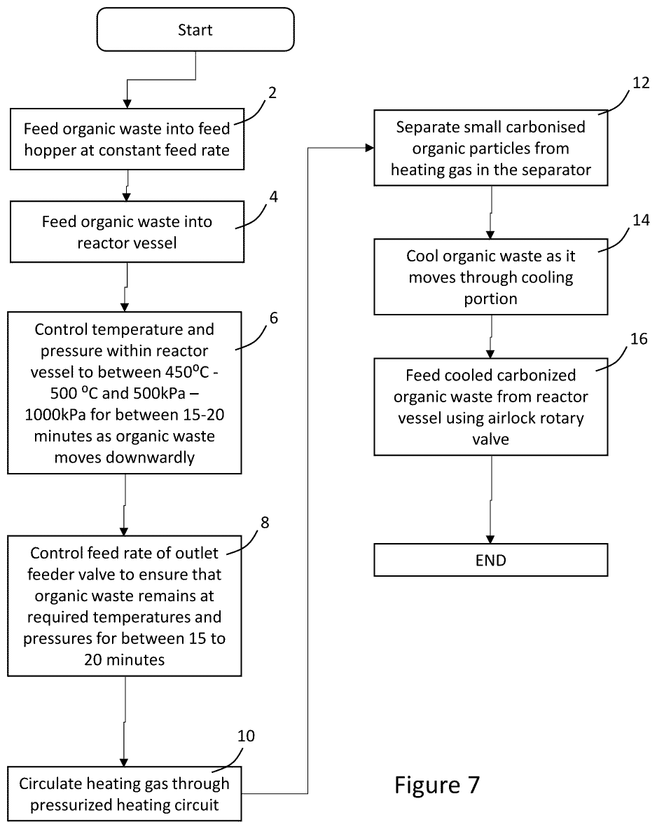

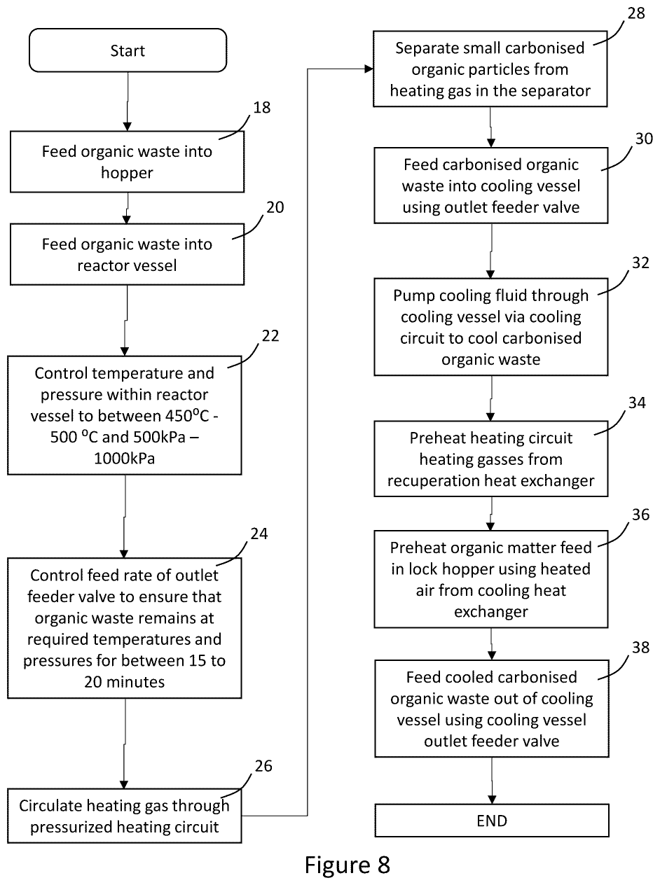

Now described with reference to FIGS. 7 and 8, a method of treating organic matter is provided. The process of treatment of organic waste involves subjecting the organic waste temperatures in the range of 300° C.-500° C., and at a pressure of between 3 bar and 10 bar in an oxygen deficient environment for approximately 15-20 minutes or more. Under these conditions, it is envisaged that the solid component of organic waste can be converted to between 93% and 99% char, depending on the type of organic waste input.

Preferably the pressurised heating circuit is filled with an inert gas such as nitrogen, and maintained at a pressure of between 3 bar (300 kPa) and 12 bar (1200 kPa), more preferably between 5 bar (500 kPa) and 10 (1000 kPa), and most preferably between 8 bar (800 kPa) and 10 bar (1000 kPa). This pressure will fluctuate as the processes described below eventuate. Alternative gases other than nitrogen are envisaged, including helium, hydrogen, carbon dioxide, carbon monoxide, argon, ethylene, hydrogen chloride, hydrogen sulphide, neon or any preferably non-explosive combination of these.

The method described in FIG. 7 is intended for use with the organic carbonisation system shown in FIGS. 1, 4, 5, and 10. Now described with reference to FIG. 7, it is envisaged that organic matter to be treated will initially be dried and pelletised before being fed 2 to a feed hopper 1020.

From the feed hopper 1020, it is envisaged than intermediate step may be taken of feeding the organic matter into a pressurised inlet lock hopper 1130 by a lock hopper feeder valve 1132 as described above, although this is not shown in FIG. 7. In feeding the organic matter into the lock hopper, it should be noted that the pressure within the lock hopper 1130 will not be varied significantly due to the preferred use of a rotary valve to feed the organic matter into the lock hopper.

Now described with reference to FIG. 7, the organic waste will then be fed 4 into the reactor vessel at a continuous feed rate of discrete amounts without changing the pressure within the reactor vessel. As discussed above, the organic waste may be fed into the reactor vessel from the feed hopper by a rotary valve, or from the lock hopper 1130 by a similar valve.

Once the organic waste is within the reactor vessel, it will settle into a fluidised or packed bed of pellets, filling the reactor vessel 1100 from its lower end, or from the perforated butterfly or gate valve 1197 as shown in FIG. 10.

The controller 1900 will then control 6 the temperature and pressure within the reactor vessel to between 450° C. to 500° C. and between 500 kPa to 1000 kPa. Simultaneously, the controller 1900 will also control 8 the feed rate of the outlet feeder valve 1180 in order to ensure that the organic matter is heated to the required temperatures as it moves through the heating portion 1160, and is sustained at these temperatures and pressures for between 15 and 20 minutes as it moves through both the heating portion 1160 as well as the intermediate portion 1190.

Heating gas will be fed into the reactor vessel at a point below or at the bottom end 1162 of the heating portion 1160. Heated gas will rise through the heating portion 1160, heating the organic waste until it is at the required temperature and carbonisation begins. It is expected that the carbonisation reaction will be an exothermic reaction in that it releases additional heat into the reactor vessel. It is anticipated that an uninterrupted hollow reactor vessel will allow for the exothermic heat generated to be used effectively in the packed or fluidised bed of the organic waste pellets in the heating portion.

As the heated organic waste travels downwardly will continue to be heated up while it is in the heating portion 1160. Once the organic waste passes to a point lower than the heating inlet arrangement 1140 at the bottom end 1162 of the heating portion 1160, it will be at the correct temperature and pressure to be undergoing the carbonisation reaction. As it moves through the intermediate portion, the carbonisation reaction will continue.

In the embodiment shown in FIG. 10, once the carbonised organic waste moves into the cooling portion 1170 by dropping below the level of the cooling outlet 1152, the cooling fluid of the cooling circuit 1700 will start to cool the carbonised organic matter down.

In the embodiment shown in FIG. 11, the organic matter will be carbonised in the intermediate portion in the reactor vessel and will continue to move down until it is fed into the cooling vessel 1300. Once it is moved into the cooling vessel, the cooling fluid of the cooling circuit will cool the carbonised organic waste. Similarly, the carbonised organic waste can be cooled by the cooling heat exchanger 1720 as shown in FIG. 12, or by the hollow fins as shown in FIG. 5.

Applicant believes that providing an uninterrupted hollow reactor vessel in which heating and carbonisation can take place, whether with or without additional heat being input into the heating of the organic waste by the exothermic reaction of the carbonisation reaction, the process of carbonisation is streamlined, and blockages and unnecessary wear on moving parts is avoided.

While the organic matter is moving downwardly through the reactor vessel, the OCS will circulate 10 heating gas through the pressurised heating circuit to ensure that the heating gas remains at the requisite temperatures.

Simultaneously, small particles of carbonised organic particles that have made their way into the heating circuit may be separated 12 by the separator in order to reduce wear on the heating circulation pump 1420.

Once the organic waste has been carbonised by moving through the heating portion 1160 and intermediate portion 1190 while being subjected to the temperatures and pressures described above for the amount of time described above, the organic waste will move downwardly into the cooling portion 1170. As the carbonised organic matter moves through the cooling portion, it will be cooled 14 by cooling fluids, preferably in the form of cooling gases from the cooling circuit 1700.

Once the carbonised organic matter has been cooled to a sufficient degree, the cooled carbonised organic matter will be fed sixteen from the reactor vessel by the outlet feeder valve 1180, preferably into a cooling waste bin 1030.

Another embodiment of a method of treating organic matter is now described with reference to FIG. 8. The method described is intended for use together with the embodiments of an organic carbonisation system shown in FIGS. 6 and 9. In this embodiment, the initial steps are the same as FIG. 7 in that organic waste is initially fed 18 into the feed hopper.

From the feed hopper 1020, the organic matter may be fed to a pressurised inlet lock hopper 1130 by a lock hopper feeder valve as described above, although this is not shown in FIG. 8. In feeding the organic matter into the lock hopper, it should be noted that the pressure within the lock hopper will not be varied significantly.

At this stage, the organic waste will then be fed 20 into the reactor vessel at a continuous feed rate of discrete amounts without changing the pressure within the reactor vessel. Once the organic waste is within the reactor vessel, it will settle into a fluidised or packed bed of pellets, filling the reactor vessel from its lower end. The controller 1900 will then control 22 the temperature and pressure within the reactor vessel to between 450° C. to 500° C. and between 500 kPa to 1000 kPa. Simultaneously, the controller 1900 will also control 24 the feed rate of the outlet feeder valve 1180 in order to ensure that the organic matter is heated to the required temperatures as it moves through the heating portion 1160, and is sustained at these temperatures and pressures for between 15 and 20 minutes as it moves through both the heating portion 1160 as well as the intermediate portion 1190.

While the organic matter is moving downwardly through the reactor vessel, the OCS will circulate 26 heating gas through the pressurised heating circuit to ensure that the heating gas remains at the requisite temperatures. The heating gas is preferably fed into the reactor vessel via the heating inlet arrangements described above, and the heating gas is inserted into the reactor vessel at the bottom end 1162 of the heating portion 1160, to rise up through the uninterrupted packed or fluidised bed of the heating portion. In doing so, the organic matter will start to carbonise. In carbonising, additional heat may be given off by the exothermic reaction of the carbonisation process.

Further, simultaneously the separator will separate 28 small carbonised organic particles caught in the airflow of the heating circuit.

Once the carbonised organic matter is at the bottom of the reactor vessel, it will be fed 30 into the cooling vessel using the outlet feeder valve 1180. On being received into the cooling vessel, cooling fluids preferably in the form of cooling gases will be pumped 32 through the cooling vessel via the cooling circuit to cool the carbonised organic waste.

As the cooling gases absorb heat energy from the carbonised organic matter and it is pumped through the cooling circuit, this heat will be transferred to the heating gasses in the heating circuit using recuperation heat exchanger 1800 to preheat 34 the heating circuit heating gases. The cooling gases will then be further cooled by passing the cooling gases through cooling heat exchanger 1720 before being returned to the cooling vessel. Air that is heated as it is used to cool the cooling gases in the cooling circuit at the cooling heat exchanger will preferably also be fed to the feed hopper or the lock hopper where the heated air can be used to preheat 36 the organic matter feed before it is fed to the reactor vessel.

At this stage, the cooled carbonised organic waste can be fed at the 8 out of the cooling vessel using the cooling vessel outlet feeder valve 1310.

Alternatively, it is envisaged that the cooled carbonised organic waste can also be fed into outlet lock hopper 1192 by cooling vessel outlet feeder valve 1310 before being fed from the outlet lock hopper 1192 by outlet feeder valve 1195.

It is envisaged that temperature sensors or thermocouples may be provided along the length of the reactor vessel that allows the controller to monitor the temperatures in the reactor vessel. Further, fluid velocity sensors may be provided to monitor the fluid flow of the heating circuit and/or cooling circuits. Similarly the rotary feed valves may be connected to the control system to allow the control system to monitor the feed rate of the rotary valves (whether inlet or outlet valves). Additionally, the controller 1900 may be configured for controlling the heating effect of the heating system, either by increasing the amount of fuel fed to the primary heat source 1610, or by controlling the amount of power fed to the primary heat source 1610.

If the temperatures are becoming too hot, the controller 1900 may increase and/or decrease the rate of circulation of the heating fluid. The controller may also reduce the heating effect of the heating system 1600 by reducing the amount of fuel being fed to the primary heat source, or controlling the current to the primary heat source. Alternately and/or additionally the controller could increase the rate of feed of the rotary valves and/or the pressure of the heating fluid within heating circuit in order to ensure that the organic matter stays within the allowable time, temperature and pressure treatment ranges. For example, it may be that at higher temperatures, and for the same time periods of treatment (i.e. the same rotary valve feed rate), the same carbonisation effect is provided at lower pressures (and vice versa), while at lower temperatures, the same carbonisation effect is achieved by sustaining the carbonisation process for longer times by reducing the rotary valve feed rate (and vice versa). Preferably the controller will be configured for controlling the rotary valve feed rates, the pressure of the heating circuit, the heating effect of the heating system and the flow rate of the heating circuit in order to ensure that a threshold level of carbonisation is achieved for any given circumstances.

### Interpretation

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein. For the purposes of the present invention, additional terms are defined below. Furthermore, all definitions, as defined and used herein, should be understood to control over dictionary definitions, definitions in documents incorporated by reference, and/or ordinary meanings of the defined terms unless there is doubt as to the meaning of a particular term, in which case the common dictionary definition and/or common usage of the term will prevail.

The terminology used herein is for the purpose of describing particular embodiments only and is not intended to be limiting of the invention. As used herein, the singular articles “a”, “an” and “the” are intended to include the plural forms as well, unless the context clearly indicates otherwise and thus are used herein to refer to one or to more than one (i.e. to “at least one”) of the grammatical object of the article. By way of example, the phrase “an element” refers to one element or more than one element.

The term “about” is used herein to refer to quantities that vary by as much as 30%, preferably by as much as 20%, and more preferably by as much as 10% to a reference quantity. The use of the word ‘about’ to qualify a number is merely an express indication that the number is not to be construed as a precise value.

Throughout this specification, unless the context requires otherwise, the words “comprise”, “comprises” and “comprising” will be understood to imply the inclusion of a stated step or element or group of steps or elements but not the exclusion of any other step or element or group of steps or elements.

The term “real-time” for example “displaying real-time data,” refers to the display of the data without intentional delay, given the processing limitations of the system and the time required to accurately measure the data.

As used herein, the term “exemplary” is used in the sense of providing examples, as opposed to indicating quality. That is, an “exemplary embodiment” is an embodiment provided as an example, as opposed to necessarily being an embodiment of exemplary quality for example serving as a desirable model or representing the best of its kind.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

### In Accordance With

As described herein, ‘in accordance with’ may also mean ‘as a function of’ and is not necessarily limited to the integers specified in relation thereto.

### Composite Items

As described herein, ‘a computer implemented method’ should not necessarily be inferred as being performed by a single computing device such that the steps of the method may be performed by more than one cooperating computing devices.

Similarly objects as used herein such as ‘web server’, ‘server’, ‘client computing device’, ‘computer readable medium’ and the like should not necessarily be construed as being a single object, and may be implemented as a two or more objects in cooperation, such as, for example, a web server being construed as two or more web servers in a server farm cooperating to achieve a desired goal or a computer readable medium being distributed in a composite manner, such as program code being provided on a compact disk activatable by a license key downloadable from a computer network.

### Wireless

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

### Processor

In a similar manner, the term “processor” may refer to any device or portion of a

device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Networked or Multiple Processors

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means for Carrying out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

The organic carbonisation system and method described herein, and/or shown in the drawings, are presented by way of example only and are not limiting as to the scope of the invention. Unless otherwise specifically stated, individual aspects and components of the organic carbonisation system and method may be modified, or may have been substituted therefore known equivalents, or as yet unknown substitutes such as may be developed in the future or such as may be found to be acceptable substitutes in the future. The organic carbonisation system and method may also be modified for a variety of applications while remaining within the scope and spirit of the claimed invention, since the range of potential applications is great, and since it is intended that the present invention be adaptable to many such variations.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### Chronological Order

For the purpose of this specification, where method steps are described in sequence, the sequence does not necessarily mean that the steps are to be carried out in chronological order in that sequence, unless there is no other logical manner of interpreting the sequence.

### Markush Groups

In addition, where features or aspects of the invention are described in terms of Markush groups, those skilled in the art will recognise that the invention is also thereby described in terms of any individual member or subgroup of members of the Markush group.

### Industrial Applicability

It is apparent from the above, that the arrangements described are applicable to the waste disposal industries.

1. An organic carbonisation system (OCS) for carbonizing of organic matter, the organic carbonisation system comprising:
a. a pressurisable reactor vessel, the reactor vessel being configured for receiving organic matter in use via an inlet and for heating received organic matter by heat transfer from heated working gas under pressure while feeding the received organic matter along a substantially hollow uninterrupted heating portion to an outlet;
b. a pressurised heating circuit including a circulation fan and a heating arrangement adapted for heating pressurised working gas, the pressurised heating circuit being adapted for moving the pressurised heated working gas between the reactor vessel, a circulation fan and a heating arrangement;
c. an inlet feed valve configured for feeding organic matter into the reactor vessel via the inlet while the reactor vessel is under pressure, while maintaining pressure in the reactor vessel; and
d. an outlet feeder valve configured for feeding carbonised organic matter from the reactor vessel via the outlet while the reactor vessel is under pressure, while maintaining pressure in the reactor vessel.

2. The OCS as claimed in claim 1, wherein the reactor vessel is configured for heating the organic matter under pressure using one or more selected from:
a. an uninterrupted fluidised bed arrangement; and
b. an uninterrupted packed bed arrangement.

3. The OCS as claimed in either of claim 1 or 2, wherein the reactor vessel is configured for feeding heated working gas into the reactor vessel at a bottom end of a heating portion at a heating inlet arrangement.

4. The OCS as claimed in any of claims 1 to 3, wherein the reactor vessel includes a cooling portion in which organic matter is cooled, wherein the cooling portion includes at least one or more cooling inlet arrangements for feeding cooling gas from the cooling circuit into the reactor vessel.

5. The OCS as claimed in any of claims 1 to 4, wherein the reactor vessel includes an intermediate portion located between the heating portion and the cooling portion in which a carbonisation is allowed to occur.

6. The OCS as claimed in any of claims 1 to 5, wherein the OCS includes a cooling vessel, and wherein the outlet of the reactor vessel feeds into an inlet of the cooling vessel.

7. The OCS as claimed in any of claims 1 to 6, wherein the OCS includes a cooling circuit.

8. The OCS as claimed in any of claims 6 to 7, wherein the cooling vessel includes at least one or more cooling inlet arrangements for feeding cooling gas from the cooling circuit into the reactor vessel.

9. The OCS as claimed in any of claims 7 to 8, wherein the cooling circuit is pressurisable.

10. The OCS as claimed in any of claims 7 to 8, wherein the cooling circuit is at ambient pressure.

11. The OCS as claimed in any of claims 7 to 10, wherein the OCS includes a heat transfer arrangement for transferring heat from the cooling circuit to the heating circuit.

12. The OCS as claimed in any of claims 7 to 11, wherein the cooling circuit includes a second heat transfer arrangement for removing heat from the cooling circuit.

13. The OCS as claimed in any of claims 1 to 12, wherein the organic carbonisation system includes a controller, the controller including a processor operationally connected to digital storage media configured for storing data and/or software instructions.

14. The OCS as claimed in claim 13, wherein the OCS includes at least one or more sensors operationally connected to the controller, the sensors allowing the controller for monitoring factors affecting the carbonisation reaction in the reactor vessel including one or more selected from:
a. the temperature of the heating working gas;
b. the pressure of the heating working gas;
c. the heating effect of the heating arrangement;
d. the flow speed of the heated working gas in the heating circuit;
e. the flow speed of the cooling gas in the cooling circuit;
f. the feed rate of the inlet feed valve to the reactor vessel; and
g. the feed rate of the outlet feeder valve from the reactor vessel.

15. The OCS as claimed in claim 14, wherein the controller is configured for controlling any of the factors affecting the carbonisation reaction to ensure that the organic matter is subjected to a combination of the following conditions in an oxygen-reduced environment for approximately 15-20 minutes or more:
i. a pressure of 3 bar (300 kPa) and 12 bar (1200 kPa); and
ii. temperatures in the range of 300° C.-500° C.

16. The OCS as claimed in claim 15, wherein the controller is configured for:
a. detecting a temperature increase in the reactor vessel due an exothermic reaction of carbonisation o the organic matter, and
b. adjusting the factors affecting the carbonisation reaction accordingly.

17. An organic carbonisation system (OCS) for the carbonisation of a feed of organic matter in a continuous process, the carbonisation system comprising:
a. a pressurizable reactor vessel comprising an uninterrupted hollow vertical heating portion in which organic matter can be heated;
b. a gas heating system adapted for heating one or more selected from pressurised heating gas and organic matter;
c. wherein the reactor vessel is adapted for receiving organic waste from a rotating feed valve and is configured for heating received organic waste in one or more selected from a packed bed and a fluidised bed.

18. The OCS as claimed in claim 17, wherein the gas heating system is configured for heating organic matter within the reactor vessel by feeding heated gas in the bottom of the heating portion and retrieving the heated gas from the top of the heating portion.

19. The OCS as claimed in either of claim 17 or 18, wherein the gas heating system includes a microwave heating system.

20. The OCS as claimed in claim 19, wherein the microwave heating system is configured for heating organic matter within the reactor vessel.

21. The OCS as claimed in any of claims 17 to 20, wherein the OCS includes a pressurised heating circuit adapted for guiding pressurised heating gas between the heating portion of the reactor vessel, a circulation fan and the gas heating system.

22. The OCS as claimed in any of claims 17 to 21, wherein the reactor vessel defines a cooling portion in which heated organic matter is cooled.

23. The OCS as claimed in any of claims 17 to 22, wherein the OCS further comprises a pressurised cooling circuit adapted for moving a pressurised cooling gas between
a. a cooling portion adapted for receiving hot carbonised organic waste from the pressurised heating circuit,
b. a circulation fan, and
c. a cooling heat exchanger adapted for cooling the pressurised cooling gas.

24. The OCS as claimed in claim 23, wherein the cooling circuit includes a first cooling heat exchanger and a second cooling heat exchanger.

25. The OCS as claimed in claim 24, wherein the first cooling heat exchanger is configured for transferring heat from the cooling circuit to the heating circuit.

26. The OCS as claimed in any of claim 23 or 24, wherein the second cooling heat exchanger is configured for cooling the cooling circuit from ambient air.

27. The OCS as claimed in any of claims 17 to 26, wherein the organic carbonisation system further comprises a cooling system.

28. The OCS as claimed in any of claims 22 to 27, wherein the cooling portion is located in a cooling chamber.

29. The OCS as claimed in any of claims 17 to 28, wherein the OCS includes a pre-heating arrangement.

30. The OCS as claimed in claim 29, wherein the pre-heating arrangement is configured for using energy in the hot carbonised organic waste received from the reactor vessel to preheat one or more selected from:
a. the organic waste feed; and
b. the pressurised heating gas of the heating system.

31. A method of treating organic matter, the method comprising the steps of:
a. feeding organic waste into a pressurised reactor vessel at an upper inlet using one or more selected from:
i. a trickle valve; and
ii. an airlock rotary valve;
b. heating the organic waste in an uninterrupted vertically oriented hollow heating portion of the reactor vessel using a pressurized dioxygen reduced heating gas to cause the organic waste to carbonise;
c. feeding the carbonised organic waste out a lower outlet to cause the carbonising organic waste to move downwardly along the reactor vessel; and
d. cycling the heating gas through a pressurised heating circuit via a circulation pump and a heat exchanger to reheat the heating gas.

32. The method as claimed in claim 31, wherein the method includes the step of:
a. directing the reheated heating gas to a lower end of the heating portion and retrieving heating gas from the reactor vessel at an upper end of the heating portion.

33. The method as claimed in either of claim 31 or 32, wherein the method includes the step of:
a. directing the reheated heating gas to the underside of one or more selected from a packed bed and a fluidised bed of organic matter in the carbonisation reactor vessel.

34. The method as claimed in any of claims 31 to 33, wherein the method includes the step of:
a. feeding carbonised organic waste organic waste into a cooling portion.

35. The method as claimed in claim 34, wherein the method includes the step of:
a. directing cooling gas through a bed of carbonised organic waste in the cooling portion.

36. The method as claimed in claim 35, wherein the method includes the step of:
a. cycling the cooling gas through a pressurised cooling circuit via a circulation pump and a heat exchanger to cool the cooling gas.

37. The method as claimed in either of claim 35 or 36, wherein the method includes the step of:
a. transferring heat in the heated cooling gas to the heating circuit via a heat exchanger.

38. The method as claimed in any of claims 31 to 37, wherein the method includes the step of:
a. utilising a preheating arrangement to transfer heat from carbonised organic waste to an organic waste feed to be fed to the carbonisation reactor vessel, to thereby preheat the organic waste feed.
